(19) United States
(12) Patent Application Publication
(10) Pub. No.: US 2008/0098886 A1
(43) Pub. Date: May 1, 2008

(54) PISTON ASSEMBLY AND METHOD OF MANUFACTURING PISTON ASSEMBLY

(75) Inventors: Robert C. Lindsten, St.Charles, IL (US); Glenn E. Nobis, Hanover Park, IL (US)

Correspondence Address: BELL, BOYD & LLOYD, LLP, P.O. Box 1135, CHICAGO, IL, 60690, US

(73) Assignee: Hydro-Components Research and Development Corporation, Streamwood, IL (US)

(21) Appl. No.: 11/553,851

(22) Filed: Oct. 27, 2006

(51) Int. Cl. F16J 9/00

(52) U.S. Cl. 92/248

(57) ABSTRACT

A hydraulic piston apparatus includes a piston having a piston body movable along an axis, the piston body having a substantially cylindrical shape, a radius, and an outer wall extending substantially parallel to the axis, the outer wall having at least one portion that defines a cavity having a first width and a second width, the second width being greater than the first width and disposed radially inward from the first width. The cavity is configured to apply a retaining force to an attachment during use.

### BACKGROUND

Certain metal pistons used in hydraulic applications include a polymer based layer applied to an exterior surface of the piston to provide a high-tolerance and low friction seal between the outer surface of the piston body and the interior surface of the hydraulic cylinder. Depending upon the operating conditions and other factors, these polymer layers physically separate from the underlying piston at times. As a result, certain piston bodies have been designed to include one or more annular grooves formed into the exterior surface of the piston prior to applying the polymer material. Though the known annular grooves can decrease some level of movement of the polymer layer, the layer can still slip on, or separate from, the piston depending upon the operation conditions. This slippage or separation can decrease the effectiveness of the seal between the piston and cylinder, increasing the incidence of wear to the piston, and increasing the incidence of piston and seal ring failure. Therefore, there is a need to overcome the disadvantages described above, or otherwise lessen the effects of such disadvantages.

### SUMMARY

The present disclosure generally relates to a hydraulic piston apparatus, a method of manufacturing a hydraulic piston apparatus, a piston and cylinder assembly and method of manufacturing same.

The hydraulic piston apparatus, in one embodiment, includes a cylindrical piston body and a plastic overmold. The cylindrical piston body includes: (a) one or more annular grooves formed into the exterior surface of the piston body; (b) a central interior bore to accommodate a piston rod; (c) a rotation obstructer formed the annular groove; and (d) an annular seal ring groove formed through the plastic overmold and into at least a portion of the metal piston body, where the annular seal ring groove accommodates a seal ring. The plastic overmold is formed about the outer peripheral surface of the piston body and includes an outer cylinder engagement surface.

The formation of the plastic overmold is accomplished by: (a) placing the piston body in a mold; (b) heating the piston body to a desired temperature; (c) heating the overmold material to a molten or semi-molten state; (d) pumping the molten overmold material into a void space between the mold and the outer peripheral surface of the piston body; and (e) allowing the piston body and the overmold material to cool so that the overmold material solidifies about the piston body and in the annular grooves. As the overmold material is allowed to cool, it contracts in the radial direction so as to form a press-fit connection with the rotation obstructer.

In one embodiment, the rotation obstructer includes a plurality of different widths. The rotation obstructer effectively minimizes or reduces the plastic overmold from separating from and rotating with respect to the piston body.

Additional features and advantages are described herein, and will be apparent from, the following Detailed Description and the figures.

### BRIEF DESCRIPTION OF THE FIGURES

FIG. 1 is a partial cross-sectional view of the piston body and plastic overmold according to an embodiment.

FIG. 2 is a perspective view of a piston-cylinder assembly according to an embodiment.

FIGS. 3A and 3B are perspective and cross-sectional views, respectively, of an embodiment of a cylindrical piston body having a plurality of annular dovetail grooves formed therein.

FIGS. 4A and 4B are perspective and cross-sectional views, respectively, of the embodiment shown in FIGS. 3A and 3B, where a plastic overmold is applied to the outer peripheral surface of the cylindrical piston body.

FIGS. 5A and 5B are perspective and cross-sectional views, respectively, of an embodiment of a cylindrical piston body having a plurality of annular dovetail grooves formed therein.

FIGS. 6A and 6B are perspective and cross-sectional views, respectively, of the embodiment shown in FIGS. 5A and 5B, where a plastic overmold is applied to the outer peripheral surface of the cylindrical piston body, and where an annular seal ring groove is formed partially into the plastic overmold.

FIGS. 7A and 7B are perspective and cross-sectional views, respectively, of an embodiment of a cylindrical piston body having a plurality of annular grooves formed therein, where the side surfaces of each annular groove include rectangular annular recesses that function as the rotation obstructer.

FIGS. 8A, 8B and 8C are a perspective view, a cross-sectional front view, and a cross-sectional side view, respectively, of an embodiment of a cylindrical piston body having a plurality of annular dovetail grooves formed therein, where bottom surfaces of the grooves include a plurality of conical bores formed therein.

FIG. 9A is a perspective view of one embodiment of the piston apparatus, illustrating a cylindrical piston body having a plurality of dovetail grooves formed into the outer peripheral surface of the piston body.

FIG. 9B is a cross-sectional view of the embodiment of the piston apparatus shown in FIG. 9A.

FIG. 10 is a cross-sectional view of one embodiment of the piston apparatus, illustrating a piston body having a first portion fixed to a second portion.

### DETAILED DESCRIPTION

In one embodiment, the piston of the piston assembly includes a plug or cylinder that is slideable within the inside bore of a cylinder. The piston is operable to either change an enclosed volume inside the cylinder, or to exert a force on a fluid inside the cylinder. The piston is operable in high-pressure hydraulic piston and cylinder apparatuses such as in heavy construction equipment applications. In one example, the piston is functional in a high-pressure hydraulic application, where an excavator has hydraulic cylinders and pistons to actuate movement of a boom, arm, thumb or bucket attached to the body of the excavator.

1. Piston-Cylinder Assembly

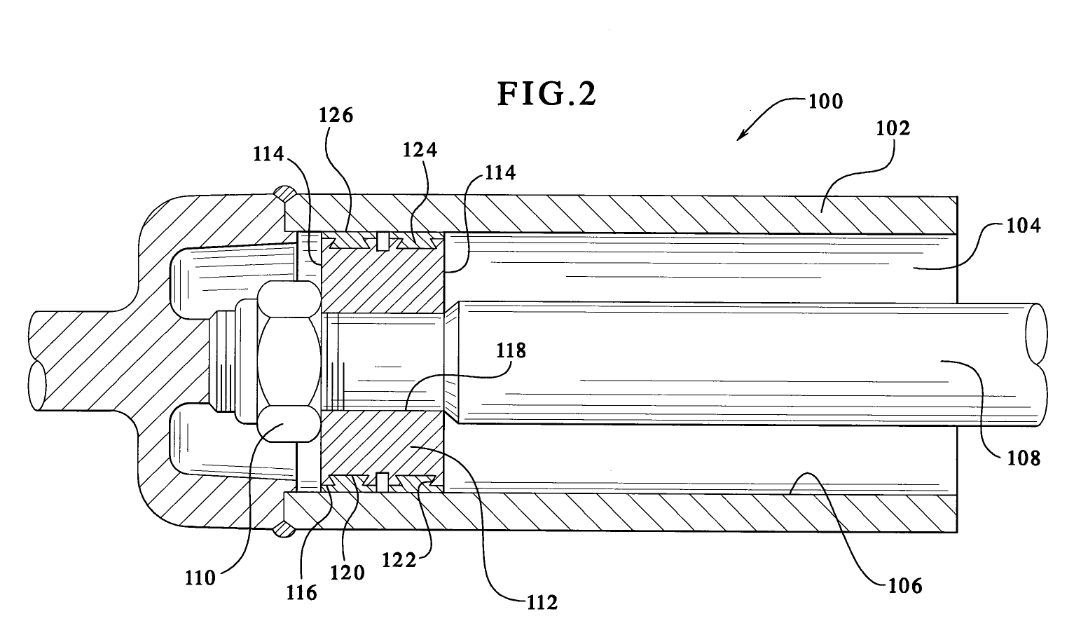

Referring now to the drawings, FIG. 2 illustrates an embodiment of a piston-cylinder assembly 100. In this embodiment, the assembly 100 includes a cylinder 102 having an interior bore 104, where the interior bore defines an interior surface 106. In one embodiment, the cylinder 102 material is a metal or metal alloy of the type typically used in high pressure hydraulic applications. However, it should be appreciated that the cylinder may be any other suitable material such as a ceramic material or polymer based material. A piston rod 108 is centrally aligned in the interior bore 104 of the cylinder 102. The piston rod is inserted through the interior bore of the piston apparatus and further secured to the piston apparatus by a nut 110.

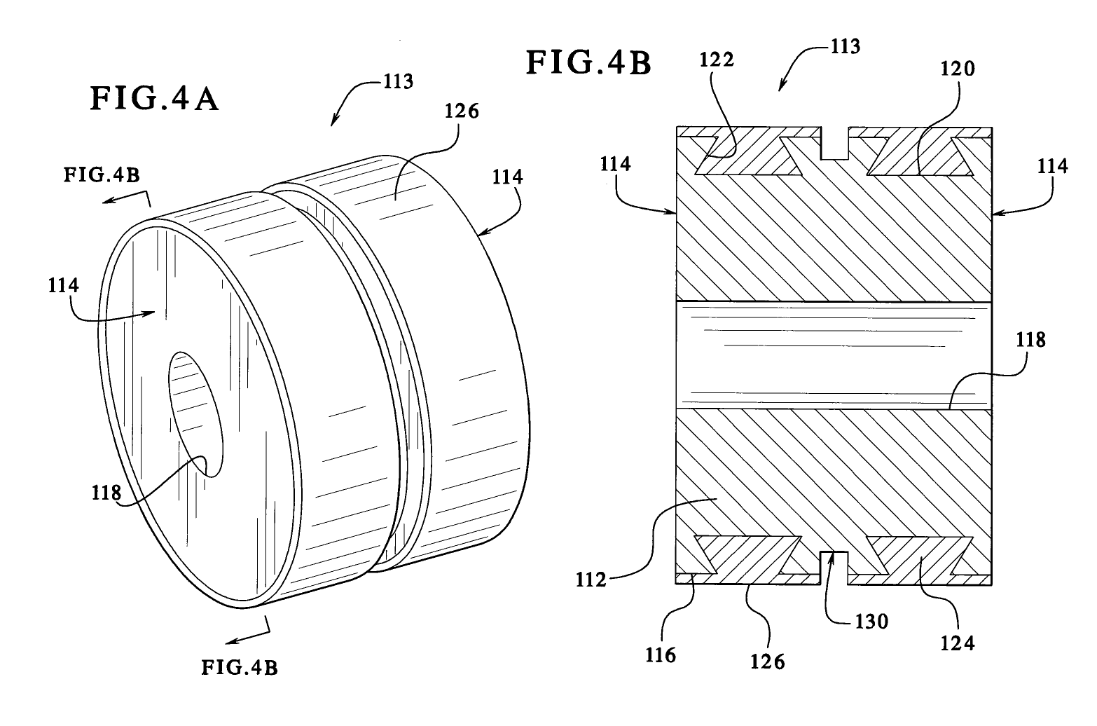

In an embodiment, as illustrated in FIG. 2, the piston-cylinder assembly includes a piston apparatus 113 (see, FIG. 4A) that is slidably engageable with the interior bore of the cylinder 104. The piston apparatus 113 includes a cylindrical piston body 112 and a plastic overmold 124. Referring to FIG. 2, the cylindrical piston body 112 includes end faces 114 and a central interior bore 118. The piston body 112 also includes at least one annular groove or channel 120. The annular groove 120 functions, at least in part, to decrease or regulate lateral movement of the plastic overmold 124 (described in detail below) along an axis of rotation of the piston body 112. The annular groove further includes a rotation obstructer. In one embodiment, the rotation obstructer includes a dovetail profile peripherally formed into the sidewalls of the annular groove. The dovetail rotation obstructer 122 functions, at least in part, to decrease or regulate rotation of the plastic overmold 124 with respect to the piston body 112 (described in detail below). Accordingly, the annular groove 120 including the dovetail rotation obstructer 122 cooperate to securely fix the plastic overmold 124 to the piston body 112.

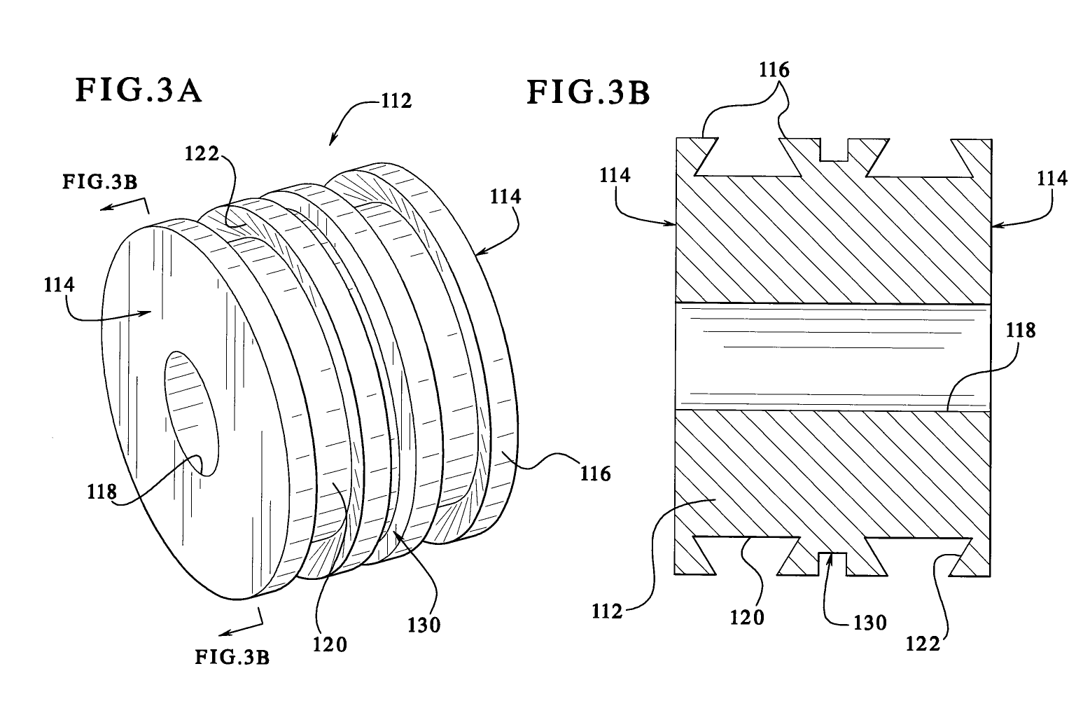

In an embodiment, the piston body also includes an annular seal ring groove 130, as shown in FIGS. 3A and 3B. In general, the annular seal ring groove is located in a central lateral position of the cylindrical piston body 112 and accommodates a sealing ring or other sealing member (not shown). The seal ring includes an outer surface that is in sealing slidable engagement with the interior surface 106 of the cylinder. Accordingly, the sealing ring functions, in cooperation with the plastic overmold 124, to maintain the hydraulic fluid on one side of the piston apparatus 113 and to guide the piston apparatus 113 along the interior bore of the cylinder. In one embodiment, as illustrated in FIGS. 4A and 4B, the annular seal ring groove or channel 130 is formed after the formation of the plastic overmold 124 and extends radially through the plastic overmold 124 and into a portion of the metal piston body.

As mentioned above, the piston apparatus 113 includes a plastic overmold 124 formed into the annular groove or channel 120. In one embodiment, the plastic overmold is composed of a glass-filled nylon material. In general, it should be appreciated that the overmold material should allow for an adequate tolerance, low friction and low wear seal between the piston body 112 and the interior surface 106 of the cylinder. The overmold 124 may function as a guide ring for the piston body. It should be appreciated that the overmold 124 material may include any suitable plastic, glass or carbon filled polymer, or combination thereof suitable for use as a bearing material in a hydraulic or pneumatic application.

In an example process for forming the plastic overmold 124, the cylindrical piston body 112 is first cleaned with an appropriate degreasing material and then placed concentrically within a mold cavity (not shown). Optionally, one or more surfaces of the piston body 112 may have a surface roughness or knurling applied thereto in order to increase friction between the piston body and the plastic overmold. After being placed in the mold cavity, the piston body 112 is heated to a temperature of about 175° C. to about 250° C. In general, it should be appreciated that the metal cylindrical piston body should be heated to a temperature sufficient to reduce or minimize immediate cooling and hardening of the liquid plastic overmold material. Although a temperature range of about 175° C. to about 250° C. is described above, it should be appreciated that the piston body may be heated to a sufficiently higher or lower temperature depending on the melting temperature of the selected plastic or polymer overmold material. After the cylindrical piston body 112 is heated, the plastic overmold material is heated to a liquid or semi-liquid state. The plastic overmold material is then pumped into the mold cavity (not shown) to flow into and fill the void space defined between the interior surface of the mold cavity and the outer peripheral surface 116 and annular groove or channel 120 of the cylindrical piston body 112. Any air contained with the void space is appropriately expelled through a venting means in the mold (not shown). After the overmold material has completely filled the void space, the piston body 112 and the plastic overmold 124 are allowed to cool. The outer surface of the plastic overmold is machined with a lathe to a desired tolerance. Although the plastic overmold material is a glass-filled nylon material in the above-described example, it should be appreciated that the overmold material may be any suitable material that exhibits a adequate tolerance and low friction seal between the outer cylinder engagement surface 126 of the plastic overmold 124 and the interior surface 106 of the cylinder 102.

In an embodiment, the plastic overmold material has a coefficient of thermal contraction/expansion that is greater than the coefficient of thermal contraction/expansion of the cylindrical piston body 112. In one example, where the cylindrical piston body 112 is a metal such as steel and the plastic overmold 124 is a glass-filled nylon material, the glass-filled nylon material has a larger coefficient of thermal contraction/expansion than the steel. Therefore, when the piston body 112 and overmold material 124 are allowed to cool, the plastic overmold 124 and the piston body 112 contract radially inward to a certain degree. In addition, the thickness of the plastic overmold decreased upon cooling. However, as the plastic overmold 124 material has a larger coefficient of thermal contraction, the radial contraction will be greater than the radial contraction of the cylindrical piston body 112. Accordingly, the plastic overmold 124 contracts in upon the piston body 112 to form a frictional connection. However, as discussed above, this frictional connection may not be sufficient to reduce or minimize separation and rotation of the plastic overmold 124 with respect to the cylindrical piston body 112.

In addition to the radial contraction upon cooling, the thickness of the plastic overmold 124 material also decreases, as mentioned above. Therefore, without a rotation obstruction structure such as the dovetail rotation obstructer 122 described above (i.e., as in a simply rectangular annular groove), the plastic overmold 124 could separate from the annular channel or groove 120 formed into the piston body 112. Therefore, without a rotation obstructer 122 the frictional connection between the plastic overmold and the piston body could become compromised. However, according to this embodiment, the dovetail rotation obstructer 122 of the piston body 112 has an inwardly sloping surface 122 that provides a normal force upon the cooling operation to oppose slippage of the plastic overmold 124 material with respect to the inclined surface. Therefore, upon cooling, the dovetail rotation obstructer 122 effects an improved press-fit frictional seal between the plastic overmold 124 and the piston body 112. Accordingly, rotational movement and separation of the plastic overmold 124 with respect to the piston body 112 is effectively reduced or minimized.

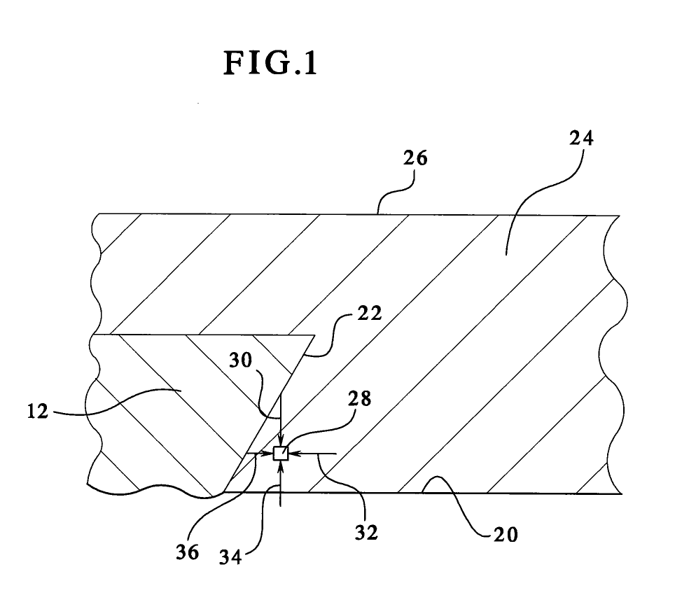

FIG. 1 illustrates the forces acting on an element 28 of the overmold material 24, where the overmold 24 has been formed in the rotation obstructer of the piston body 12. In this embodiment, the rotation obstructer has an inner surface 20 contactable with a portion of the piston body 12 and an outer surface 26 that is a cylinder engagement surface. In this embodiment, the rotation obstructer is a dovetail shaped groove having a slanted surface 22. Force elements 30 and 36 are force components acting on the element 28 from the slanted surface 22. Force component 34 acts on the element 28 from the piston body 12. Force element 32 acts on the element from the corresponding slanted surface (not shown) of the dovetail groove (see also, reference numeral 122 in FIG. 3B).

2. Annular Seal Ring Groove Extending Partially Through Overmold

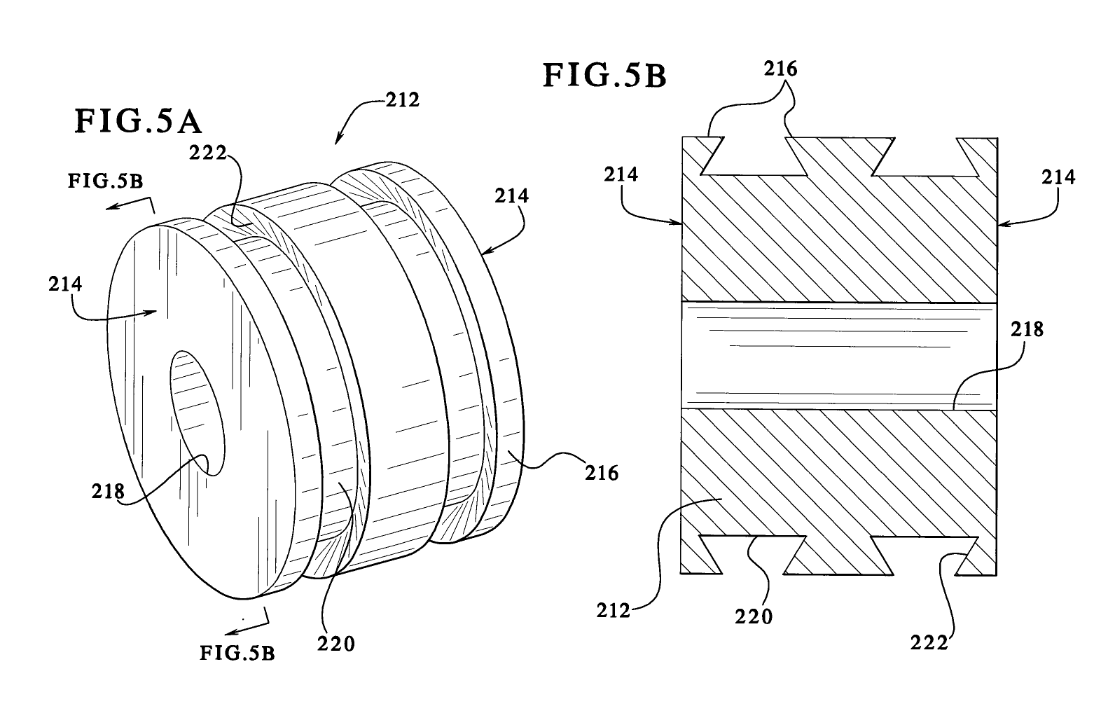

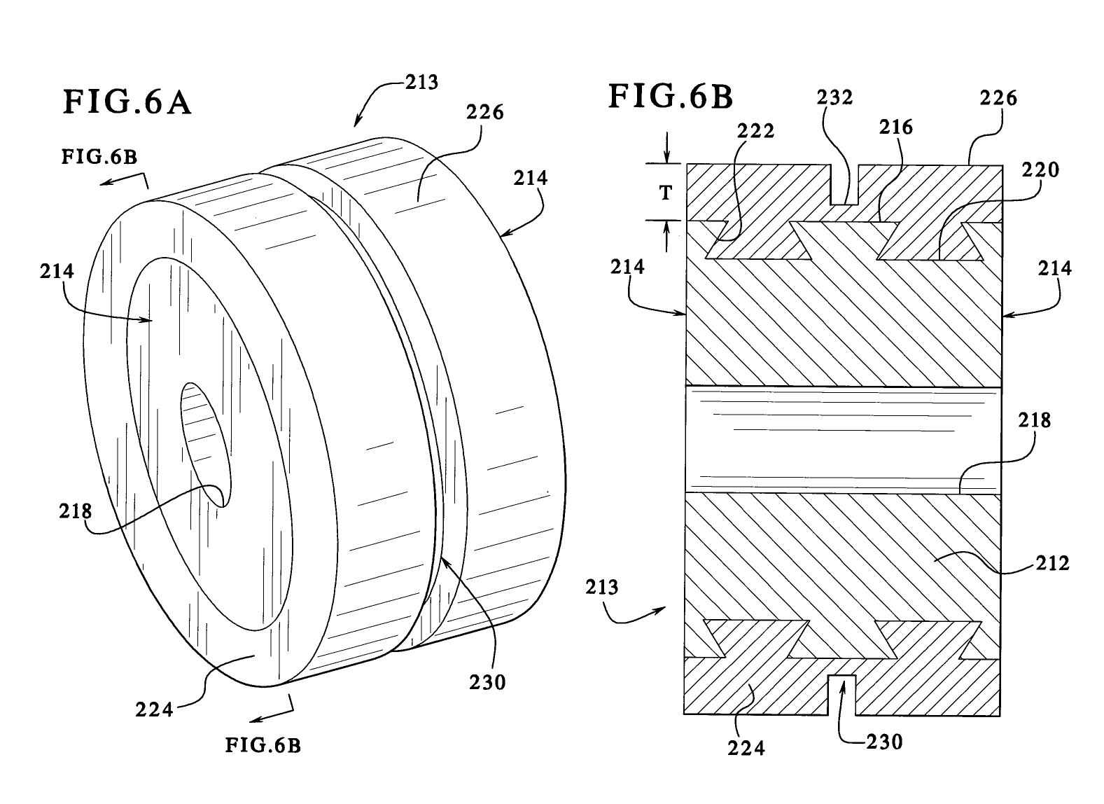

Referring to FIGS. 5A and 5B, in one embodiment, the piston apparatus 213 includes a piston body 212 having end faces 214, an outer peripheral surface 216 and a central interior bore 218. In this embodiment, the piston body 212 includes an annular groove or channel 220 having a dovetail-type rotation obstructer 222, as described above with reference to FIGS. 1, 2A, 2B, 3A and 3B. Referring to FIGS. 6A and 6B, the piston apparatus 213 also includes a plastic overmold 224 having an outer cylinder engagement surface 226. In this embodiment, the plastic overmold 224 has a thickness T defined by the distance between the outer peripheral surface 216 of the piston body and the outer cylindrical engagement surface 226 of the plastic overmold (see, FIG. 5B). This thickness T is greater than the depth of the annular seal ring groove 230 formed into the outer cylinder engagement surface 226 of the plastic overmold 224. Therefore, the bottom surface 232 of the annular seal ring groove does not extend into the metal cylindrical piston body 212. Accordingly, when the annular seal ring groove 230 is formed, the plastic overmold 224 is not split into two pieces as in the embodiment described above with respect to FIG. 4B. Also, the bottom surface 232 that engages the seal ring (not shown) is the plastic overmold material rather than the metal material of the piston body.

3. Rotation Obstructer Including a Rectangular Recess

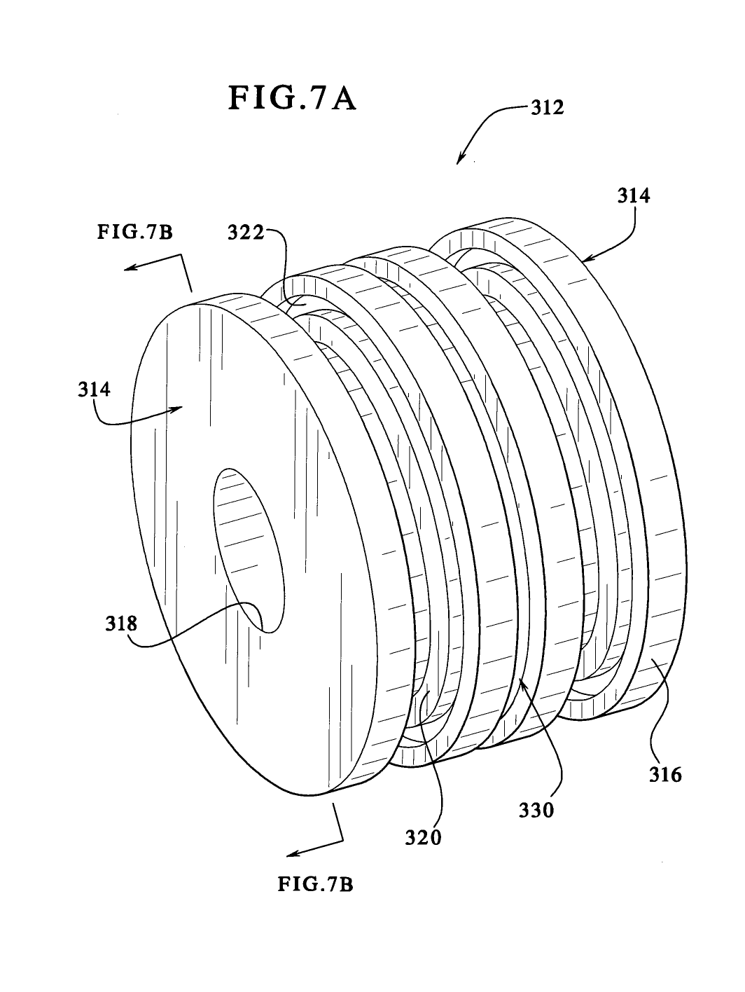

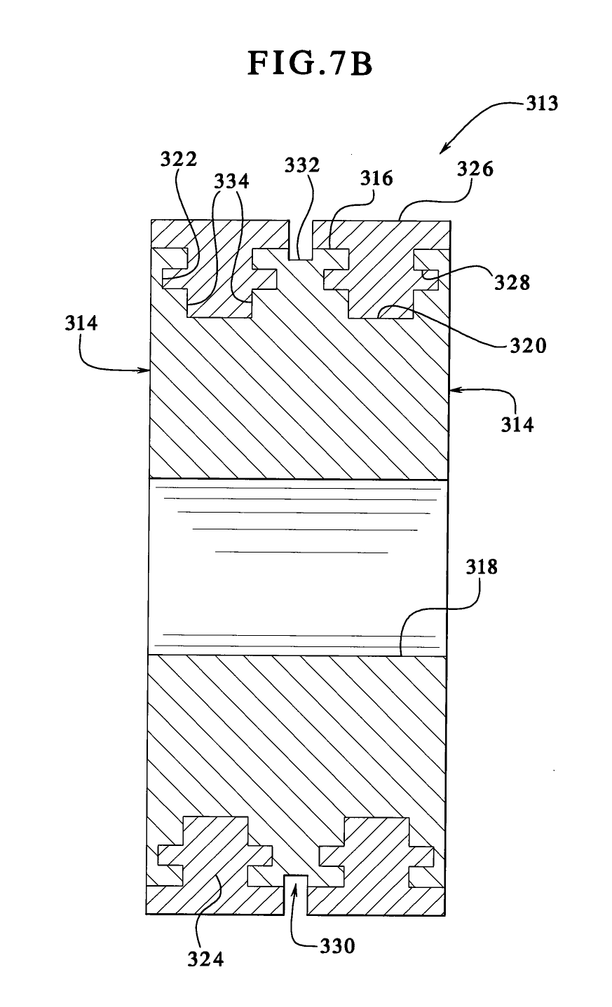

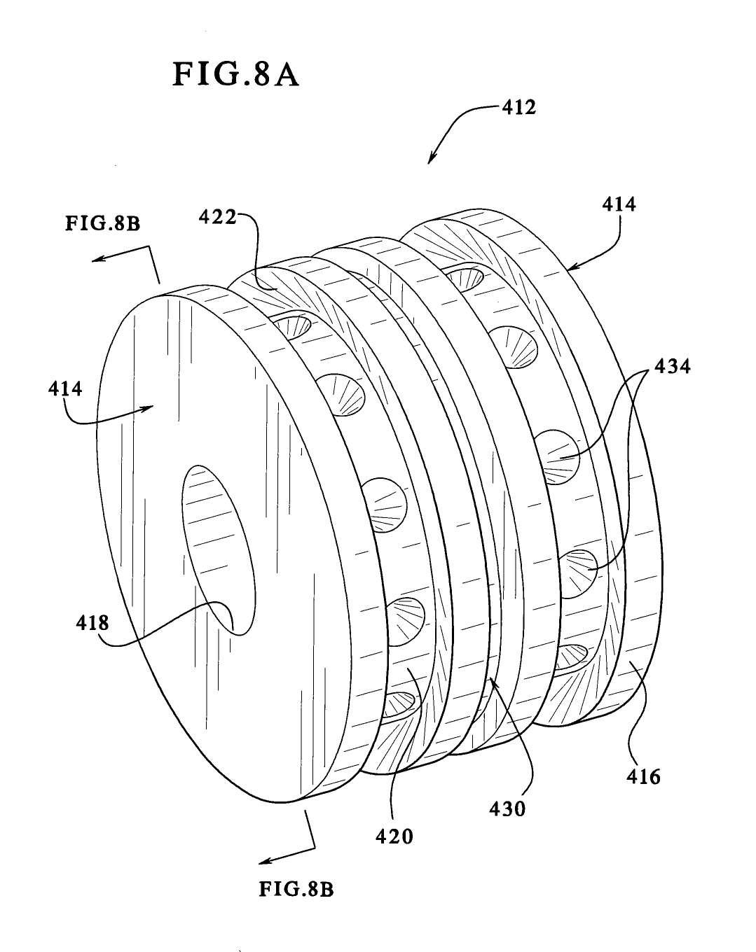

Referring to FIGS. 7A and 7B, in one embodiment, the piston apparatus 313 includes a piston body 312 having end faces 314, an outer peripheral surface 316 and a central interior bore 318. In this embodiment, the piston body 312 includes an annular groove or channel 320 having an annular rectangular recess 332 that functions as the rotation obstructer 320. As mentioned above, the plastic overmold 324 tends to contract in upon the piston body 312 upon cooling to form a frictional connection. Also, the thickness of the plastic overmold 324 material decreases to a certain degree. In this embodiment, the rectangular recess 332 rotation obstructer of the piston body 312 has an upper surface 328 that opposes thermal contraction of the plastic overmold 324 material to effect an improved press-fit or shrink-fit frictional seal between the plastic overmold 324 and the piston body 312. Therefore, the press-fit or shrink-fit seal reduces or minimizes separation of the plastic overmold 324 with respect to the piston body. Accordingly, any rotation of the plastic overmold 324 with respect to the cylindrical piston body 312 is effectively obstructed, reduced or minimized.

It should be appreciated that, although the structure of a rotation obstructer 320 has been described above with respect to a dovetail profile and a rectangular recess 322 formed into the sidewalls 334 of the annular groove 320 formed into the piston body, the rotation obstructer 320 included in the piston body 312 can include any suitable recess formed into the surface of the piston body, where the recess includes at least one surface oriented in such a manner as to: (a) oppose contraction of the plastic overmold material upon cooling; or (b) oppose the operating forces acting on piston apparatus 313 in operation. With regard to opposing contraction upon cooling, the overmold 324 volumetrically contracts to a greater degree that the piston body 312 such that the surface of the piston body obstructs at least a portion of the possible contraction. In operation, the overmold 324 expands slightly due to an increase in temperature. Because the overmold 324 has a radial thermal expansion associated with an increase in temperature the surface opposes said expansion. In one example, where the piston body 312 includes one or more annular groove or channels as described above, the rotation obstructer may be a circular recess formed into the sidewall of the annular groove, a circular nodule extending from the side walls of the annular groove, a triangular or notched structure extending into or out the side walls, or any other suitable structure or profile that includes at least one surface that opposes the contraction of the plastic overmold. The surface may be inwardly slanted as in the examples of the dovetail profile or triangular notches structure. The opposing surface may be curved as in the example of the circular or ovular notch. Moreover, the opposing surface may be substantially coplanar with respect to the outer cylindrical engagement surface 326 of the plastic overmold as in the example of the rectangular recess. Therefore, at least one opposing surface of the rotation obstructer provides an opposing force to the plastic overmold 324 upon cooling to effect a press-fit seal. Accordingly, rotation of the plastic overmold 324 with respect to the piston body 312 can be effectively reduced or minimized.

4. Rotation Obstructer Including Conical Bores

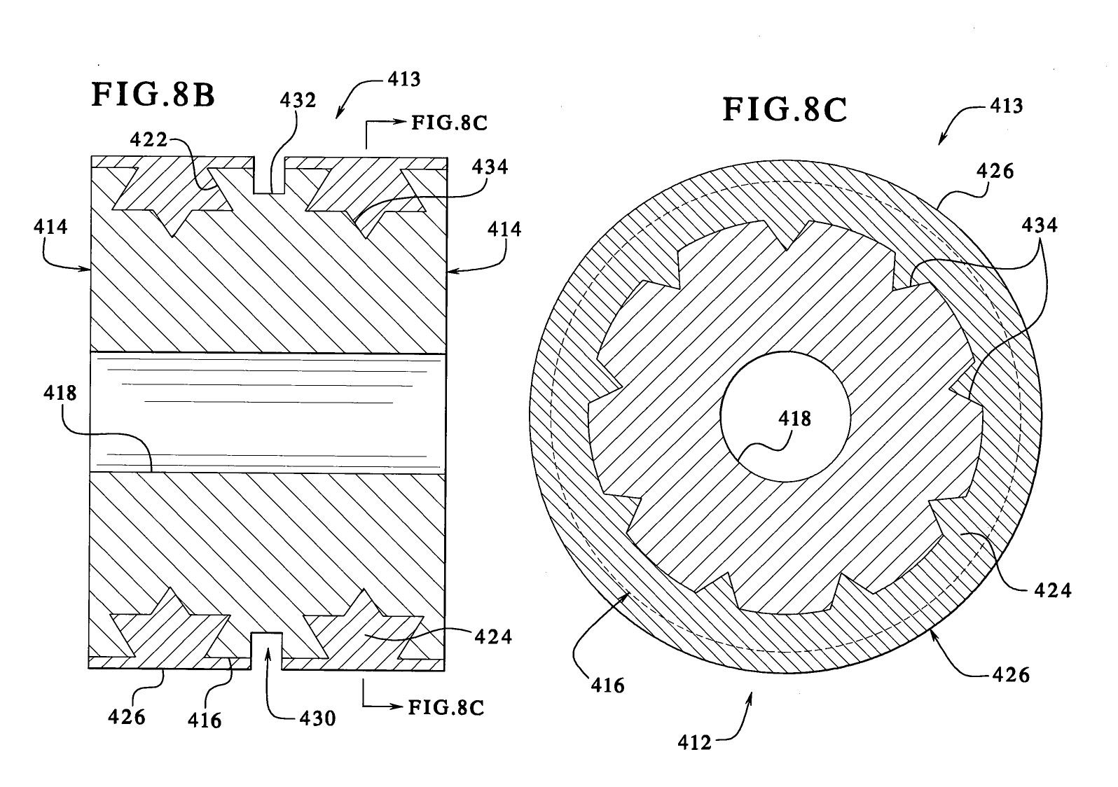

Referring to FIGS. 8A, 8B and 8C, in one embodiment the piston apparatus 413 includes a cylindrical piston body 412 and a plastic overmold 424. The cylindrical piston body 412 includes end faces 414 and a central interior bore 418. The piston body 412 also includes at least one annular groove or channel 420. As described above, the annular groove 420 functions, at least in part, to reduce or minimize lateral movement of the plastic overmold 424 with respect to an axis of rotation of the piston body 412. The annular groove further includes a rotation obstructer 422 including a dovetail profile peripherally formed into annular groove or channel 420. The piston body 412 also includes an annular seal ring groove 430 having a bottom surface 432. As described above, the annular seal ring groove 430 accommodates a seal ring (not shown). In addition to the dovetail rotation obstructer described above, a plurality of conical bores 434 are formed into the bottom surface of the annular grooves or channels 420. The conical bores 434 cooperate with the dovetail rotation obstructer 422 to reduce or minimize rotation of the plastic overmold 424 with respect to the piston body 412.

When the liquid plastic overmold material is introduced into the mold cavity (not shown), the overmold material fills the annular grooves and also fills the conical bores. The slanted surface of the conical bores further reduces or minimizes the tendency of the cured or cooled plastic overmold to rotate with respect to the piston body (i.e., they modify the smooth cylindrical profile of the annular grooves).

It should be appreciated that the conical bores could alternatively be any suitable geometry such as a rectangular recess, a square recess, a cylindrical bore or any other suitable shape. It should also be appreciated that the additional rotation obstruction structures may be protrusions that extend radially away from the bottom surface of the annular groove 420, or may be any combination of protrusions and recesses or bores. Similar to the recesses or bores described above, a suitable protrusion would also cooperate with the dovetail rotation obstructer 422 to reduce or minimize rotation of the plastic overmold with respect to the piston body. It should also be appreciated that the above described recesses, bores 434 and/or protrusions may be utilized with other suitable primary rotation prevention structures other than the dovetail rotation obstructer 422, such as in the embodiment described above having rectangular recesses 322 formed in the sidewalls of the annular groove 320 of the piston body 312 (see, FIGS. 7A and 7B).

5. Rotation Obstructer Including a Plurality of Dovetailed Grooves

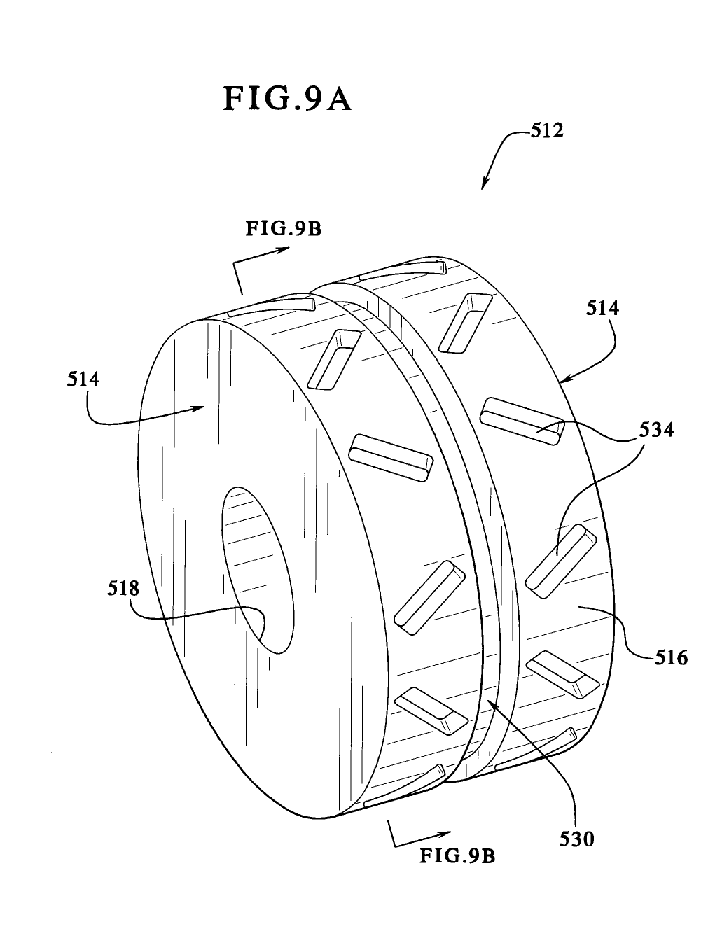

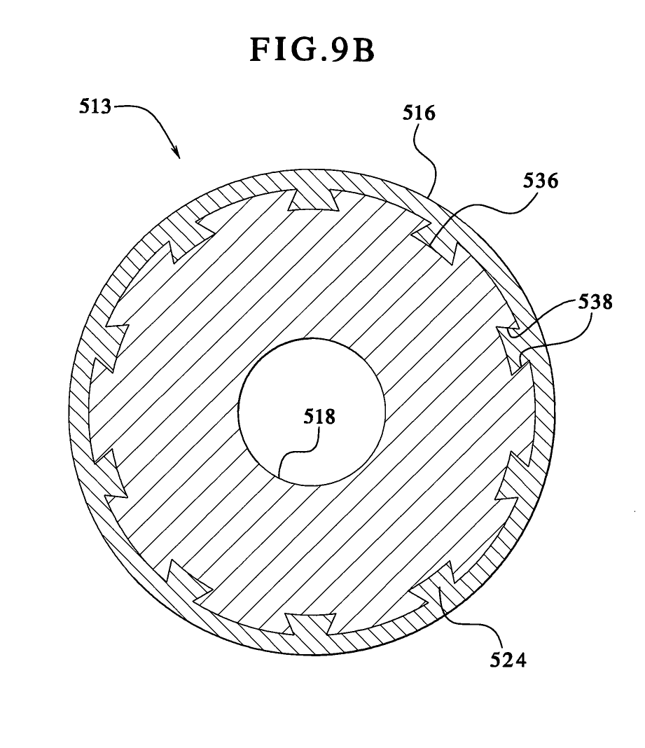

Referring to FIGS. 9A and 9B, in one embodiment the piston apparatus 513 includes a cylindrical piston body 512 and a plastic overmold 524. The cylindrical piston body 512 includes end faces 514 and a central interior bore 518. The piston body 512 also includes at least one annular seal ring groove 530. In addition, the outer peripheral surface 516 of the piston body 512 includes a plurality of grooves or channels 534 formed therein. In an embodiment, the grooves or channels 534 (see, FIG. 9A) are rectangular channels including a dovetail rotation obstructer 538 (see, FIG. 9B) formed therein. The grooves are spaced radially about the outer peripheral surface 516 of the piston body 512. In an embodiment, the grooves 534 are oriented an angle relative to the axis or rotation of the cylindrical piston body 512. In the illustrated embodiment (see, FIG. 8A), the grooves are oriented at an approximate 45 degree angle relative to the axis of rotation of the piston body. However, it should be appreciated that any suitable angle may be used. Also in the illustrated embodiment, the grooves are formed at alternating forty-five degree angles. The angled grooves 534 having the dovetail rotation obstructers 522 function to reduce or minimize rotation of the plastic overmold 524 with respect to the piston body 512 and function to reduce or minimize lateral movement of the overmold with respect to the axis of rotation of the piston body. When the liquid plastic overmold material is introduced into the cavity of the mold (not shown), the overmold material fills the angled grooves. Upon a cooling step, the dovetail rotation obstructers 534 resist separation of the plastic overmold 524 from the bottom surfaces 536 of the angular grooves 534. In addition, the grooves effectively reduce or minimize lateral movement of the plastic overmold 524 when the piston is subject to the rigorous draft forces when sliding in the cylinder. Accordingly, the piston body effectively reduces or minimizes movement of the plastic overmold 524 with respect to the piston body 512.

6. Multi-Component Piston Apparatus Including Rotation Obstructer

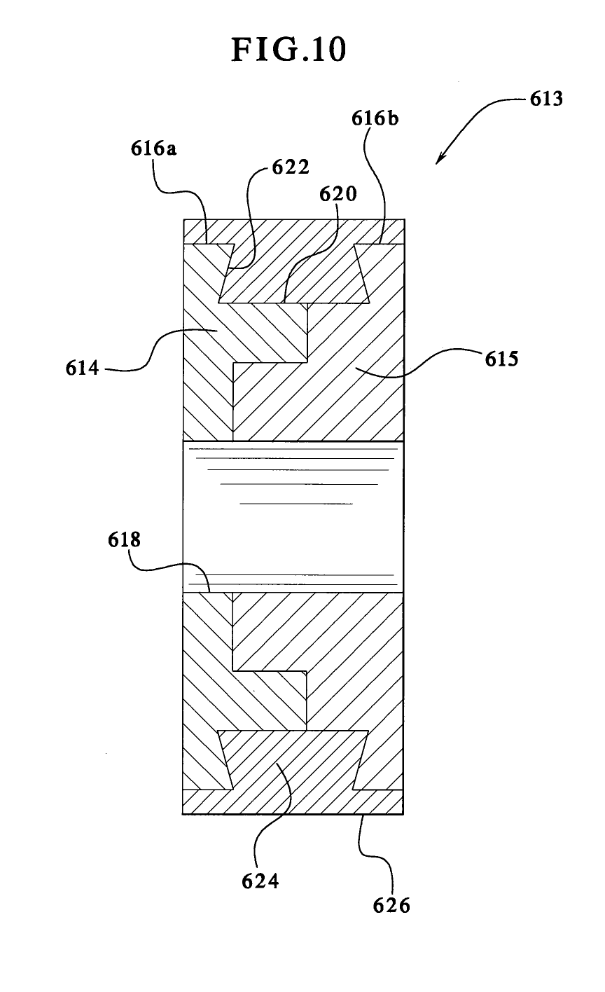

Referring to FIG. 10, in one embodiment, the piston apparatus 613 includes a first portion 614 and a second portion 615, wherein the first portion 614 is fixedly connectable to the second portion 615. After the first portion 614 is connected to the second portion 615 to form a cylindrical piston body, a central interior bore 618 is formed therein. Also, the piston apparatus 613 includes an annular groove or channel 620 formed into the outer peripheral surfaces 616a, 616b of the first portion 614 and second portion 615 of the fixedly connected piston body. In one embodiment, the annular groove 620 includes a dovetail rotation obstructer 622, as described above. A plastic overmold 624 including an outer cylinder engagement surface 626 is formed in the annular groove. As described above, the dovetail rotation obstructer 622 effects a press-fit or shrink-fit seal that reduces or minimizes rotation of the plastic overmold with respect to the piston body.

In each of the embodiments described above, the piston body includes one or more rotation prevention structures that restrict rotational movement of the applied plastic overmold material with respect to the piston body. In certain embodiments, the rotation obstructer includes a structure formed into the outer peripheral surface of the piston body, where the structure includes at least one surface that restricts thermal contraction of at least a portion of the plastic overmold material to form a press-fit or shrink-fit connection. In other embodiments, the rotation obstructer includes recessed structures or protruding structures formed into the outer peripheral surface of the piston body. Therefore, the rotation obstructers of the above-described embodiments, alone or in a suitable combination, effectively reduce or minimize the plastic overmold from separating from and moving with respect to the piston body. Accordingly, the piston apparatus minimizes or reduces wear and minimizes or reduces the incidence of seal failure in high-pressure hydraulic cylinder applications, as described above.

In one embodiment, the piston apparatus includes a suitable combination of one or more components of one or more of the embodiments described above.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A piston assembly comprising:
a piston body movable along an axis, the piston body having a substantially cylindrical shape, a radius, and an outer wall extending substantially parallel to the axis, the outer wall having at least one portion that defines a cavity having a first width and a second width, the second width being greater than the first width and disposed radially inward from the first width.

2. The piston assembly according to claim 1, including an attachment coupled to the outer wall of the piston body and engaged with the cavity.

3. The piston assembly according to claim 2, wherein the attachment has a thermal volumetric contraction characteristic that is greater than a thermal volumetric contraction characteristic associated with the piston body.

4. The piston according to claim 3, wherein the attachment forms a press-fit connection to the piston body after a volumetric contraction associated with a decrease in temperature.

5. The piston assembly according to claim 2, wherein the attachment has a polymer characteristic.

6. The piston assembly according to claim 2, wherein the attachment comprises a glass-filled Nylon material.

7. The piston assembly according to claim 1, wherein the cavity is an annular dovetail shaped groove.

8. The piston assembly according to claim 7, including a plurality of recesses formed into a bottom surface of the annular groove.

9. The piston assembly according to claim 1, wherein the cavity is an annular groove including side surfaces, a bottom surface, and an annular rectangular recess formed into at least one of the side surfaces.

10. A piston assembly usable within a cylinder device, the piston comprising:
a piston body movable along an axis, the piston body having a substantially cylindrical shape, a radius, and an outer wall extending substantially parallel to the axis, the outer wall having at least one cavity wall defining a cavity, at least a portion of the cavity wall passing through a plane which intersects with both the axis and the radius.

11. The piston assembly according to claim 10, wherein the cavity wall is selected from the group consisting of a plane, a curve, a rounded recess, a protrusion, and a notch.

12. The piston assembly according to claim 10, wherein the cavity includes an additional cavity wall which intersects the other cavity wall, the additional cavity wall further defining the cavity.

13. The piston assembly according to claim 9, wherein at least a portion of the cavity wall is inset along the axis relative to an edge of the opening.

14. The piston assembly according to claim 10, including an attachment coupled to the outer wall of the piston body, positioned within the cavity and engaged with the cavity wall, wherein the cavity wall is configured to apply a retaining force to the attachment during use of the piston assembly along an axis which is substantially parallel to the radius.

15. The piston assembly according to claim 10, including an attachment coupled to the outer wall of the piston body, positioned within the cavity and engaged with the cavity wall, wherein the cavity wall is configured to apply a first force component to the attachment along an axis which is parallel to the radius, and a second force component to the attachment along a second axis which intersects with the radius.

16. The piston assembly according to claim 15, wherein the attachment includes a cylinder device engagement surface.

17. The piston assembly according to claim 10, further including an annular seal ring groove formed through the attachment and into the outer wall of the piston body, the seal ring groove configured to receive a hydraulic seal ring.

18. The piston assembly according to claim 10, including an annular seal ring groove formed partially through the attachment, the seal ring groove configured to receive a seal ring.

19. The piston assembly according to claim 10, wherein the piston body includes a plurality of portions defining cavities, the cavities being annular dovetail shaped grooves.

20. The piston assembly according to claim 10, wherein the outer wall and the cavity wall include a surface roughness applied thereto.

21. The piston assembly according to claim 10, wherein the piston body includes a plurality of securing devices radially distributed about the outer wall of the piston body, wherein the securing devices are dovetail shaped grooves.

22. The piston assembly according to claim 10, wherein the piston body includes a first section matably connected to a second section.

23. A method for manufacturing a piston assembly comprising:
(a) forming a piston body that is movable along an axis, the piston body having a substantially cylindrical shape, a radius, and an outer wall extending substantially parallel to the axis; and
(b) forming in the outer wall at least one portion defining a cavity having a first width and a second width, the second width being greater than the first width and disposed radially inward from the first width.

24. The method of manufacturing a piston assembly according to claim 23, further comprising forming an attachment coupled to the outer wall of the piston body, where forming the attachment includes:
(a) positioning the piston body within a mold cavity;
(b) heating the piston body;
(c) filling a region of space between the mold cavity and the piston body with a liquid polymer material, the region of space including the cavity;
(d) cooling the liquid polymer material to a solid state; and
(e) removing the piston body and attachment from the mold cavity.

25. The method of manufacturing a piston assembly according to claim 24, wherein an outer wall of the attachment extends substantially parallel to the axis and is configured to engage an inner surface of a cylinder.

26. The method of manufacturing a piston assembly according to claim 24, wherein the attachment has a volumetric contraction characteristic associated with the cooling and solidifying of the liquid polymer material, and a radial expansion characteristic associated with an increase in temperature during use of the piston assembly.

27. The method of manufacturing a piston assembly according to claim 24, wherein the solidified attachment forms a press-fit connection to the piston body.

28. The piston assembly according to claim 23, wherein the cavity is an annular dovetail shaped groove.

29. The piston assembly according to claim 23, wherein the cavity is an annular groove including side surfaces, a bottom surface, and an annular rectangular recess formed into at least one of the side surfaces.

30. The method of manufacturing a piston assembly according to claim 23, wherein the portion is configured to apply a retaining force to the attachment, the retaining force including a first force component along an axis which is parallel to the radius and a second force component along a second axis which intersects with the radius.
